(19) United States
(12) Patent Application Publication
(10) Pub. No.: US 2003/0149734 A1
(43) Pub. Date: Aug. 7, 2003

(54) System and method for the efficient use of network resources and the provision of television broadcast information

(76) Inventors: Janne Aaltonen, Turku (FI); Juha Salo, Littoinen (FI); Timo Ellila, Halikko (FI)

Correspondence Address: MORGAN & FINNEGAN, L.L.P., 345 Park Avenue, New York, NY, 10154-0053, US

(21) Appl. No.: 10/066,473

(22) Filed: Feb. 1, 2002

(51) Int. Cl. G06F 15/16

(52) U.S. Cl. 709/207; 725/87

(57) ABSTRACT

A system and method for the efficient use of network resources, the provision of a webpage containing television broadcast information, and for the efficient use of network resources when that webpage is accessed by users.

### FIELD OF INVENTION

This invention relates to systems and methods for data distribution.

### BACKGROUND INFORMATION

In recent times there has been an increase in the number and variety of services that make use of network resources. Such services include video, newswire stories, webpages, software downloads, music, and the like. There has also been an increase in the number of user requests for these services. As a result, both network operators and terminal users may become more interested in using network resources efficiently and cost effectively.

Additionally, with the increase in the variety and use of these services, purveyors of more traditional forms of media, such as television station operators and owners, have become interested in integrating these traditional media forms with these new services.

### SUMMARY OF THE INVENTION

Embodiments of the present invention provide for efficient use of network resources, the provision of a webpage containing television broadcast information, and for the efficient use of network resources when that webpage is accessed by users.

### BRIEF DESCRIPTION OF THE DRAWINGS

FIG. 1 shows an exemplary broadcast information webpage of the present invention.

FIG. 2 shows a further exemplary broadcast information webpage of the present invention.

FIG. 3 is a representation of the exemplary broadcast information webpage of FIG. 1 at a later point in time.

FIG. 4 is a functional diagram relating to an exemplary broadcast information webpage implementation according to certain embodiments of the present invention.

FIG. 5 is a functional diagram relating to another exemplary broadcast information webpage implementation according to certain embodiments of the present invention.

FIG. 6 shows an exemplary general purpose computer which may be used in certain aspects of the invention.

FIGS. 5a and 7b show exemplary user interfaces and an exemplary remote control in accordance with certain embodiments of the invention.

### DETAILED DESCRIPTION OF THE INVENTION

As noted above, embodiments of the present invention provide for efficient use of network resources, the provision of a webpage containing television broadcast information, and for the efficient use of network resources when that webpage is accessed by users. These aspects will now be discussed in greater detail.

### Transmission Caching

General Operation

Certain types of data distribution networks, such as DVB-T (terrestrial Digital Video Broadcast) and DVB-S (satellite Digital Video Broadcast) operate via multicast from the data link layer point of view even when operating via unicast from the network layer point of view. In such systems, transmissions directed to a particular wireless terminal or other node, perhaps in response to a request by the node's user, are actually received by other nodes. However such transmissions are effectively ignored by these other nodes. For example, a transmission directed to a particular wireless terminal in a certain DVB-T cell is actually received by all other terminals in the cell, but these other terminals essentially ignore the transmission. According to embodiments of the present invention, the behavior in such networks may be altered to take advantage of the fact that nodes may receive transmissions directed towards other nodes and/or transmissions not requested by their users.

In such embodiments, a filter software module could operate on a node. The filter module could examine incoming transmissions, such as webpages, music, and video, for those transmissions directed to a node or nodes other than the node for which it operates. These would typically be transmissions sent in response to requests from the users of these other nodes. The module might make such a determination, for example, by monitoring incoming transmissions for those whose packets have headers specifying an IP address other than that of the node for which the module operates. Upon recognition of such a transmission, the filter module might next determine if the transmission is likely to be of interest to the user of the node for which it operates. As will be described in more detail below, the determination might include, for example, consulting a profile store indicating properties of items that are of probable interest to the node's user.

In the case where the filter module finds a particular transmission to be of probable interest to its terminal's user, the filter module could store the transmission in a preselection cache. The transmission could be stored with reference to an identifier, such as a URL (universal resource locator) and/or title associated with the transmission. Such an identifier could be added at transmission time for later extraction by filter modules running on receiving nodes. The filter module might also record in the cache for each transmission stored the date and/or time of storage and/or reception.

Also running on a node could be a request handler module. When a node's user makes a request for a particular item available for reception over a network, such as a DVB-T network, the request handler module could determine if the item existed in the preselection cache. In the case where the item did not exist in the cache, the handler module could forward the request upstream to it's conventional target, such as an internet access point, service provider, content provider, or the like. In the case where the item existed in the cache, the user's request could be fulfilled by accessing the cache. In such a case the upstream forward would not occur, nor would the item need to be transmitted to the client using the DVB-T or other network. In such cases, satisfying the user's request could involve no particular expenditure of network resources.

Because certain user requests for an item could be satisfied without transmitting an upstream request and/or without needing to transmit the requested item in response to the request, more efficient use of network resources could result. For example, spectral efficiency could be increased and bandwidth use could be decreased.

Certain above-described aspects of the present invention will now be described in greater detail.

User Specification of Content of Potential Interest

There are a number of ways in which a node user can specify to the node's profile store content items of potential interest. For example, a GUI (graphical user interface) running on the user's node could present pre-defined categories, perhaps further allowing the user to specify for each category the content type or types that would be of interest. For example, in certain embodiments the interface might present:

[ ] N.Y. Yankees Baseball

[ ] webpages

[ ] newswire stories

[ ] videos

Thus a user who selected predefined category “N.Y. Yankees Baseball” as a topic of interest could additionally specify which one or more of the three content types he was interested in receiving with relation to the selected topic.

Predefined categories could be established, for example, by a network operator. Categories could have varying levels of specificity, sometimes with overlapping coverage. For example, suppose three established categories were:

N.Y. Sports

Baseball

N.Y. Yankees Baseball

Under such circumstances, a transmission concerning the N.Y. Yankees baseball team would be associated with all three categories, because the Yankees are a New York sports team, a baseball team, and are particularly associated with the third category. On the other hand, a transmission concerning the N.Y. Mets baseball team may be associated with only the first two categories, because although the Mets are a New York sports team and a baseball team, they are not the Yankees. As a further example, a transmission concerning the Atlanta Braves baseball team would be associated with only the second category, because it is a baseball team but not a New York team nor the Yankees.

Although certain categories have been discussed here for purposes of illustration, it should be apparent that these examples are in no way limiting.

In another embodiment, the GUI might alternately or additionally allow the node's user to establish a number of rules for determining content of potential interest. Each rule could include a specification of certain keywords of interest, perhaps specified in terms of a Boolean expressions. Each rule could further include a specification of the content types to which the rule should be applied. The GUI could further allow a user to add or delete rules. Accordingly, the GUI might present an “add rule” button to the user. Upon the user's activation of this button, the GUI could present to the user a form for entering a Boolean phrase for a new rule. The GUI might further allow the user to specify the content types to which the rule should be applied. In some embodiments, the form could have the following appearance:

Rule: ______

Content Types: [ ] webpages [ ] newswire stories [ ] videos

It is specifically noted that the content types shown are for illustrative purposes only, and that the invention is in no way limited to these exemplary types.

As one example of filling out the form, the user could specify:

Rule: germany AND economics

Content Types: [ ] webpages [X] newswire stories [ ] videos

This rule would specify that the user is likely to be interested in all newswire stories containing the phrases “Germany” and “economics”.

As another example, the user could use the GUI to enter the rule:

Rule: “Christopher walken” AND (“dead zone” OR “pennies from heaven”)

Content Types: [X] webpages [X] newswire stories [X] videos

This rule would specify that the user is likely to be interested in all newswire stories and webpages whose text satisfies the Boolean phrase, as well as all videos whose synopses satisfy the Boolean phrase. The concept of synopses will be described in further detail below.

Rules, chosen categories, and the like could be placed in a profile store for later use by the node's filter module. The store could exist, for example, on the node itself or on a server connected to the node via a network. Such a server could hold profile stores for a plurality of users associated with its network.

In other embodiments, specification of items of potential interest could be done in ways other than user entry via a GUI associated with a node. For example, a network operator could make entries for specific users using the GUI of a general purpose computer. The chosen rules, categories, and the like could be placed on a server holding the profile stores for a plurality of users.

Filter Module Recognition of Content of Potential Interest

As noted above a filter recognition module, upon recognition of an incoming transmission not directed to the node for which it operates, might next consult the appropriate profile store to determine if the transmission is likely to be of interest to the node's user.

In embodiments where the profile store specifies predefined categories, transmissions to mobiles might each include an indication of one or more of the predefined categories. In certain embodiments, each transmission might also include an indication of its content type or types. According to certain embodiments, such indications could be stated in headers of packets comprising the transmission.

For example in an embodiment where “entertainment update” is a category, the phrase “entertainment update”, or a tag chosen by a network operator or the link to specify this category, could be placed in packet headers of a transmission determined to be associated with this category. Such a determination could be made, for example, by a network operator or the content provider that produced the content of the transmission.

In such embodiments, the filter module would look for specifications of category, and perhaps of content type, in the headers of packets not directed to the node for which it operates. Upon recognition of one or more categories in a packet, the filter module could then consult the profile store to see if at least one of these categories had been specified by the node's user as one of interest. In certain embodiments, the consultation might also take into account the content type specified by the packet.

If the consultation produces an affirmative result, the filter module could place the transmission associated with the packet in the profile store. If the consultation produces a negative result, the filter module would not place the transmission associated with the packet in the store, and instead might ignore other packets associated with the transmission.

In embodiments where the profile store specifies rules, the filter module may act to determine if received transmissions not directed to the node for which it operates satisfy any of the rules.

In the case where the transmission contains text, such as is the case with a webpage or newswire story, the filter module may examine the text in light of the Boolean expressions of rules stated in the profile store in order to see if any of the expressions are satisfied. In the case where a rule specifies a Boolean expression but no specific transmission type or types, the module could consider the rule to be satisfied when its Boolean expression is satisfied. In the situation where a rule additionally states a transmission type or types, the module might not consider the rule to be satisfied unless this requirement was satisfied as well. In certain embodiments, each transmission might include an indication of its content type, and the filter module could determine satisfaction of a rule's requirement for certain content types by examining this indication. In certain embodiments of the invention, such indications could be stated in headers of packets comprising a transmission. Such an indication might also be specified, for example, by imbedding it in a portion of the corresponding transmission's text, perhaps in a manner that it would not be displayed to a user that views the transmission. This could be done, for example, through appropriate use of HTML (hypertext markup language) tags.

In the case where a transmission does not inherently contain text—as is the case with a sound, image, movie, or the like—the transmission may be adapted to include a synopsis of the content and/or certain keywords. In certain embodiments, included with the keywords or the synopsis could be an indication of the content type. Such content type information may also be included, for example, in packet headers. Synopsis, keyword, and/or content type information could be used by the filter module in a similar manner to that described above with reference to transmissions such as webpages that inherently contain text.

Preselection Cache Management

According to certain embodiments of the invention, also operating on a node may be a preselection cache management module. The management module might decide when items should be deleted from the cache. In certain embodiments the module might also decide when items in the cache should be compressed. Compression could be performed in a number of ways known in the art. For example, GNUzip, Zip, or Stufflt compression could be used.

The management module could be designed to delete or compress items under certain conditions. As noted above, a storage time may be associated with items placed into the preselection cache. The management module could be designed to delete items after a certain amount of time had elapsed since storage time. The management module might also be designed to compress items after a certain amount of time had elapsed since storage time. In certain embodiments, the elapsed time relating to deletion could be longer than the elapsed time relating to compression.

In further embodiments, a notation may be made in the preselection cache whenever an item is accessed. In such embodiments the management module might take into consideration the last time that an item was accessed when contemplating deletion or compression. For example, the management module might be designed to delete items after a certain amount of time had elapsed since last access. The management module might also be programmed to compress items after a certain amount of time had elapsed since last access. In certain embodiments, the elapsed time relating to deletion could be longer than the elapsed time relating to compression.

In still further embodiments, the management module could be designed to take into account the amount of storage space left in the cache when considering deletion and/or compression of items.

### Broadcast Information Webpage

According to certain embodiments of the present invention, there may be provided a broadcast information webpage (BIW) for displaying information related to a particular television channel's broadcasting. The webpage could display data relating to a television item, such as a commercial, program, or the like, currently being broadcast by the television channel, or alternately a link to such data. Additionally, the webpage may display links to data relating to one or more television items recently broadcast by the television channel. In certain embodiments, the webpage could be accessible over the internet so as to be available to any device equipped with an appropriate web browser.

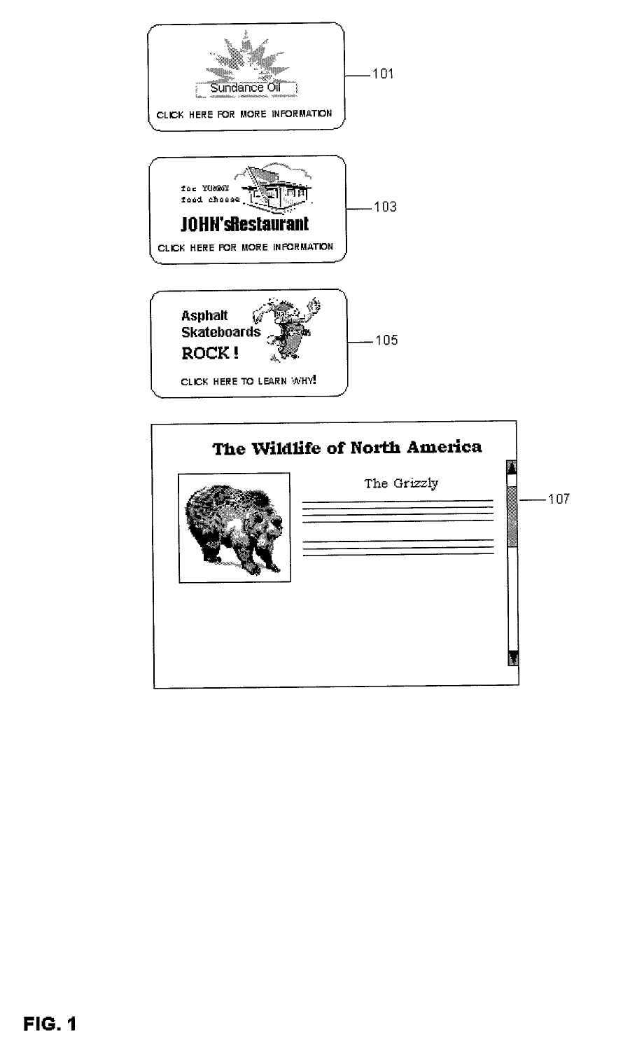

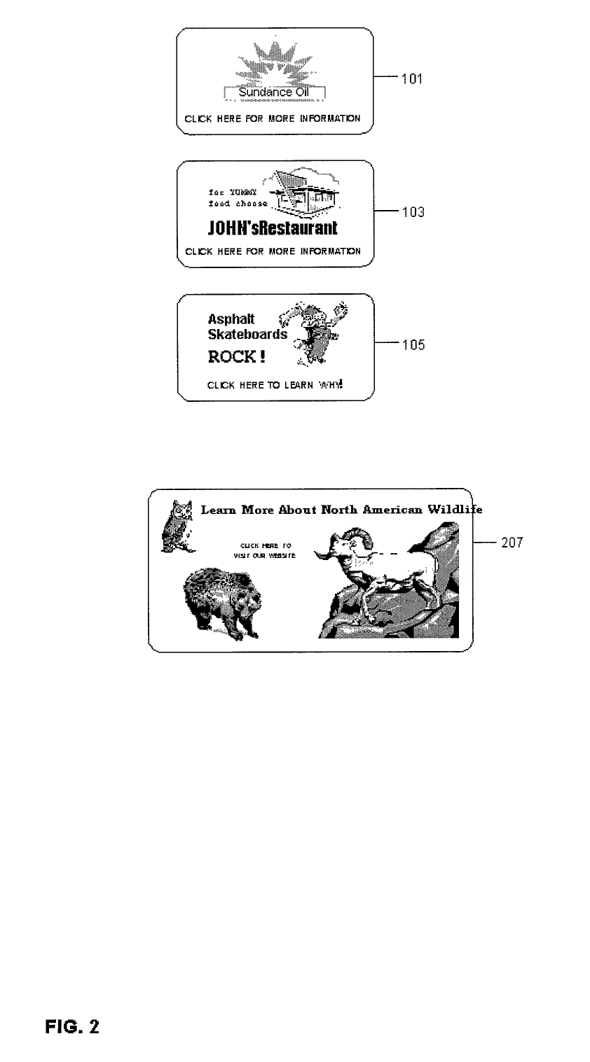

FIG. 1 represents an exemplary BIW according to an embodiment of the present invention. Icons 101, 103, and 105 correspond to television items recently broadcast on a particular television channel. Icon 105 corresponds to the most recent of the three items last broadcast, icon 103 to the second most recent item of the three, and icon 101 to the least recent item of the three. Thus icons 101-105 might be said to relate to an ordinal group consisting of the first through third most-recently broadcast items. Although icons are shown relating to the last three items broadcast, this is for exemplary purposes only. For example, icons may be shown relating to the last five items broadcast or the last two items broadcast.

Furthermore, embodiments of the invention may allow the user to select the number of icons shown relating to items previously broadcast. For example, a BIW could provide a pull-down menu allowing a user to select the number of icons relating to items previously broadcast that should be shown. The functionality for complying with the user's request could be implemented, for example, using Java servlets, JSP (Java Server Pages), and/or ASP+ (Active Server Pages+). In certain embodiments, the number of items shown could be changed during the time a user is viewing a television item. Furthermore, as will be described in more detail below, certain embodiments make use of caching. In such embodiments, the number of items selected by the user might be limited by the number of items that could be stored in the cache.

In the example of FIG. 1, icon 101 corresponds to a recently-broadcast commercial for Sundance Oil, icon 103 corresponds to a recently-broadcast commercial for John's Restaurant, and icon 105 corresponds to a recently-broadcast commercial for Asphalt Skateboards. Frame 107 corresponds to an item currently being broadcast on that television channel, in this case a television program about the wildlife of North America.

Icons 101-105 act as hyperlinks to data corresponding to their respective television items. These may be, for example, hyperlinks to webpages, online films, or the like. Frame 107 displays data corresponding to its respective television item. For example, frame 107 may contain a webpage, online film, or the like corresponding to the television program about the wildlife of North America. FIG. 2 shows an exemplary BIW similar to that of FIG. 1, the difference being that frame 107 has been replaced by icon 207. Icon 207, like the previously-described icons 101-105, acts as a hyperlink to data corresponding to its respective television item. Thus icon 207 might act as a hyperlink to the data that is presented in frame 107. In this exemplary embodiment, icon 207 is of a larger size than icons 101-105. This larger size is intended to serve, for example, to indicate to a user of the webpage that the icon corresponds to the television item currently being broadcast.

A BIW may be updated along with the broadcasts of its corresponding television channel. Accordingly, exemplary icons 101-105 could be updated to always correspond, for example, to the last three items broadcast, if the user has made a selection for three, while 107 and 207 would be updated to always correspond to the item currently being broadcast.

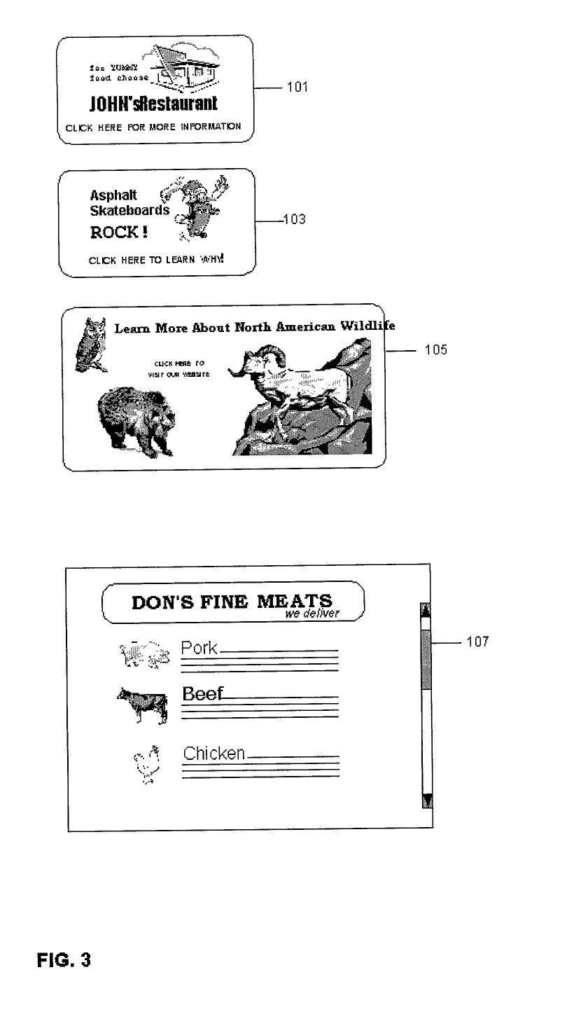

FIG. 3 represents FIG. 1 at a later point in time where a commercial break, advertising Don's Fine Meats, has occurred during the showing of the television program about the wildlife of North America. At this later time, frame 107 displays the webpage for Don's Fine Meats, since it is the data corresponding to the television item currently being broadcast, a commercial for Don's Fine Meats. As the television program about the wildlife of North America has become the most-recently broadcast item, it is now served by icon 105. Icon 103 now corresponds to what has become the second most-recently broadcast item, the Asphalt Skateboards commercial, and icon 101 now corresponds to what has become the third most-recently broadcast item, the commercial for John's Restaurant. The exemplary webpage of FIG. 2 could be updated in a similar manner.

According to certain embodiments, a user could be allowed to specify that a BIW no longer present information relating to one or more particular broadcast items. For example, with respect to FIG. 3, a user might specify that the page no longer present information relating to the broadcast item to which icon 103 corresponds—Asphalt Skateboards. In response, the Asphalt Skateboards item might no longer be considered when determining the ordinality of the broadcast items.

Prior to the user's specification, the commercial for Asphalt Skateboards is considered to be the second most-recently broadcast item, the commercial for John's Restaurant is considered to be the third most-recently broadcast item, and the commercial for Sundance Oil is considered to be the fourth most-recently broadcast item (with no information related thereto being displayed on the BIW). In response to the user's specification the determined ordinality changes such that the commercial for John's Restaurant is considered to be the second most-recently broadcast item and the commercial for Sundance Oil is considered to be the third most-recently broadcast item. Accordingly, icon 103 of FIG. 3 would correspond to the commercial for John's Restaurant while icon 101 would correspond to the commercial for Sundance Oil.

In certain embodiments, a BIW could offer a pull-down menu which allows a user to select the icon whose corresponding broadcast item should be removed from consideration. Furthermore, certain embodiments may allow a individual other than a user, such as a system administrator, television station employee, or the like to specify that the BIW no longer present information relating to a particular broadcast item.

Furthermore, according to certain embodiments of the invention a user could specify the “density” of each icon, that is the number of broadcast items to which a particular icon corresponds. For example, with reference to FIG. 3, each of the icons 101-105 correspond to a single broadcast item; icon 105 corresponds to the most-recently broadcast item, icon 103 corresponds to the second most-recently broadcast item, and icon 101 corresponds to the third most-recently broadcast item. Suppose a user specified the density of icon 105 to be three, the density of icon 103 to be one, and the density of Icon 101 to be two. Under such circumstances, icon 105 could relate to the first through third most-recently broadcast items, icons 103 could relate to the fourth most-recently broadcast items, and icon 101 could relate to the fifth and sixth most-recently broadcast items.

For icons whose density was specified to be greater than one, the icon's image might indicate, for example, that a user could click it to access information correspond to items broadcast during a certain time period. For example, an icon might state in its image:

“Click here for information corresponding to the broadcast period 2:35 p.m. to 2:55 p.m.”or

“Click here for information corresponding to the fifth and sixth most-recently broadcast items”

When a user clicks on such an icon, she might be presented with a webpage that has icon corresponding to each of the appropriate recent broadcast items. Each of these icons might link to a webpage, video, or the like relating to its broadcast item.

For example, a BIW might present to a user a button labeled “select icon densities”. Upon clicking this button, the user might be brought to a webpage that displays a pull-down menu for each BIW icon. Each pull-down menu could allow the user to select the density of its corresponding icon. Upon making the density choices, the user might click a button labeled “set densities”. Upon clicking the button, the user could be presented with a BIW relating to the selected density settings.

According to certain embodiments of the invention an individual other than a user, such as a system administrator, television station employee, or the like, could specify the density of each icon on a BIW.

In certain embodiments of the invention a BIW may further include one or more “custom icons”, each corresponding to one or more broadcast items according to a user's specifications. For example, a user could specify that a custom icon relate to all broadcast items fitting a certain profile, such as all items of a certain category (e.g., “commercials”) or all items related to a specified keyword (e.g., all items whose synopses contain a certain keyword). Categories, synopses, keywords, and the like could be associated with broadcast items by television station personnel and forwarded to the software and/or individuals responsible for creating and maintaining BIWs.

A user might also be able to specify that a custom icon relate to certain specified television items. For example, a user might click a button labeled “select items for custom icon”. In response, the user might be presented with a webpage listing recently-broadcast items that could be selected for association with a custom icon. Thus a user could specify that the third, fifth, and sixth most-recently broadcast items be associated with a particular custom icon. In certain embodiments, a custom icon could act in a manner similar to icons of densities greater than one as described above. Accordingly, a user clicking on a custom icon could be presented with a webpage that allows selection from icons corresponding to the broadcast items with which the custom icon is related. A custom icon's image might specify, for example, “all commercials”.

According to certain embodiments, a user could specify whether items associated with a custom icon should also be associated with non-custom icons. For example, suppose a BIW showed four non-custom icons relating respectively to the second through fifth most-recently broadcast items. Suppose the user specified that a custom icon should correspond to the second, fourth, and fifth most-recently broadcast items. If the user specified that these items should not be associated with non-custom icons, the BIW could have the four non-custom icons relate respectively to the third, sixth, seventh, and eighth most-recently broadcast items in a manner similar to that described above with reference to a user requesting that a BIW no longer present information relating to particular broadcast items.

In certain embodiments, an individual other than a user, such as a system administrator or television station employee, could specify the properties of a custom icon.

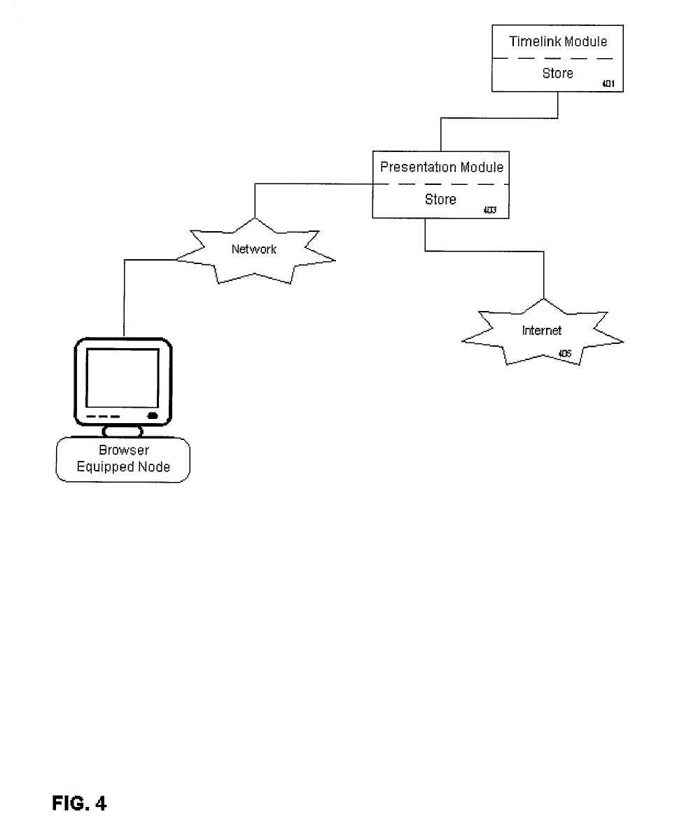

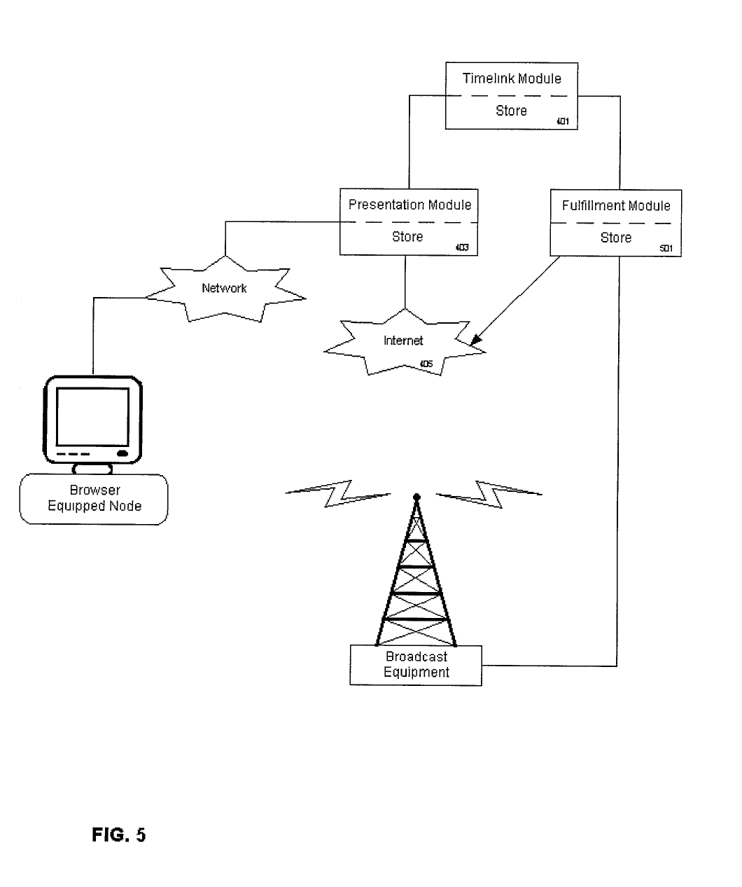

FIG. 4 is a functional diagram relating to an exemplary BIW implementation according to certain embodiments of the present invention. Timelink module 401 holds in its associated store time-of-day/hyperlink relationships. Each relationship could specify for a particular time of day the hyperlink relating to the television item currently being broadcast. The timelink module might consider the time-of-day/hyperlink relationship corresponding to the television item currently being broadcast to be the “active” time-of-day/hyperlink relationship. The relationships could correspond to the broadcast schedule for a particular television channel. For example, the timelink module's store could include time-of-day/hyperlink relationships:

Feb. 23, 2003 6:00:00 EST—6:00:30 EST:

www.donsfinemeats.com/special_tv_offer.html

Feb. 23, 2003 6:00:30 EST—6:15:00 EST: www.tvone.com/north_american_animals.html

Feb. 23, 2003 6:15:00 EST—6:15:30 EST: www.sundanceoil.com

These relationships could correspond to the portion of the broadcast day with the schedule:

Feb. 23, 2003 6:00:00 EST—6:00:30 EST: 30 sec. spot: Don's Fine Meats

Feb. 23, 2003 6:00:30 EST—6:15:00 EST: The Wildlife of North America (mins. 0-15)

Feb. 23, 2003 6:15:00 EST—6:15:30 EST: 30 sec. Spot: Sundance Oil

Time-of-day/hyperlink relationships could be loaded into the timelink module's store in several ways. For example, data entered into or loaded on a general purpose computer could be forwarded to the module. Such entry could involve, for example, a television channel employee entering the time-of-day/hyperlink data using the general purpose computer's keyboard.

In certain embodiments, the timelink module could accept suspension of stored relationships. For example, the timelink module could be instructed to suspend its loaded schedule and to consider a specified time-of-day/hyperlink relationship to be the active one until further notice. Such an instruction could be entered by a television station employee using a general purpose computer and dispatched to the timelink module by a software module interfacing with the general purpose computer. A television station employee might perform such an operation, for example, if a major news event occurred that suspended normal television programming. In certain embodiments, the timelink module could be instructed to suspend it's loaded schedule and use a substitute schedule consisting of more than one time-of-day/hyperlink relationship.

In addition to holding time-of-day/hyperlink relationships in its associated store, the timelink module could monitor the present time of day in order to keep track of which time-of-day/hyperlink relationship corresponded to the television item currently being broadcast and/or to the television item that was about to be broadcast. As will be described in more detail below, presentation module 403 could maintain the content of a BIW for viewing by a user operating an Internet browser or the like. The timelink module could inform the presentation module when the active time-of-day/hyperlink relationship changes. In certain embodiments, the timelink module could inform the presentation module in advance of the change.

As alluded to above, the presentation module can be informed by the timelink module as to which time-of-day/hyperlink relationship is currently active. Additionally, the presentation module could maintain in an associated store the relationships corresponding to one or more recently broadcast television items and could assemble a BIW for presentation to the user in accordance with the above description. For embodiments where the BIW is to show data corresponding to the currently-broadcast television item in a frame, the presentation module could have access to the Internet 405 or other network and could employ this access to populate the frame as appropriate.

In certain embodiments the presentation module may be implemented, at least in part, using one or more Java servlets and may operate in conjunction with a servlet engine. In other embodiments, the implementation of the functionality described herein could include the use of Java Server Pages, Active Server Pages, and/or Apple Computer's WebObjects.

### Broadcast Information Webpage Caching

According to embodiments of the present invention, the above-described BIW functionality may be expanded to provide for node caching of the data to which BIW hyperlinks point.

FIG. 5 is an exemplary functional diagram relating to such a BIW implementation according to certain embodiments of the present invention. This implementation is similar to that shown in FIG. 4, the main difference being the addition of fulfillment module 501.

Fulfillment nodule 501 can be informed by timelink module 401 when a new time-of-day/hyperlink relationship becomes the active time-of-day/hyperlink relationship. In some embodiments the timelink module may provide an indication of a certain amount of time before the relationship becomes active.

In response, the fulfillment module could fetch from the Internet or another network the data pointed to by the hyperlink, placing it in an associated temporary store. The data referenced by the hyperlink may contain further hyperlinks. This is the case, for example, when the data is a webpage. The depth to which the module should fetch links could be specified by a television channel employee. For example, the employee could enter such a specification using a general purpose computer and a software module could read the specification and inform the fulfillment module of the specified depth. Alternately, the depth could be specified during design of the fulfillment module. Once the data was downloaded to the temporary store, the fulfillment module might perform the additional step of compressing it.

As a next step, the fulfillment module could forward the compressed or not compressed data to the television station's transmission equipment 503 for incorporation into the broadcast stream. Incorporation may be performed in a number of ways known in the art. For example, when the television channel uses DVB-T for transmission, incorporation may be performed according to ATVEF (Advanced Television Enhancement Forum) standards.

Upon reception of the broadcast stream at a terminal, television, set-top box or the like, the received data could be extracted and placed in a store accessible by a device capable of accessing the data. For example, the device might be one equipped with a web browser and software for playing QuickTime and/or Windows Media content. In some embodiments, the store would hold the data relating to the television item currently being broadcast and, for example, to the three television items most recently broadcast. As noted above, in certain embodiments of the invention the user can select the number of items shown on the BIW.

Extraction could be performed in a number of ways known in the art. For example, when the television channel used DVB-T for transmission, extraction could be performed according to ATVEF standards. In embodiments, where the data arrived in a compressed format, decompression might occur prior to placement in the store.

In a manner similar to that described above with reference to the preselection cache, running on the device capable of accessing the data could be a request handler module. When the device's user made a request for data pointed to by a hyperlink on the BIW, or viewed a BIW with a frame displaying data, the device's request handler module could determine if the data existed on the store. In the case where the item did not exist in the store, the handler module could forward a request for the data upstream to it's conventional target, such as an internet access point, a content provider, or the like. In the case where the data existed in the store, the user's request could be fulfilled by accessing the store. In such a case the upstream forward would not occur, nor would the item need to be transmitted to the client using the DVB-T or other network. Therefore, satisfying the user's request could involve no particular expenditure of network resources.

Because certain user requests for an item could be satisfied without transmitting an upstream request and/or without needing to transmit the requested item in response to the request, more efficient use of network resources could result. For example, spectral efficiency could be increased and bandwidth use could be decreased.

### Hardware and Software

Certain aspects of the present invention may be executed by or with the help of a general purpose computer. The phrases “general purpose computer,” “computer,” and the like, as used herein, refer but are not limited to an engineering workstation, PC, Macintosh, PDA, set-top box, mobile terminal and the like running an operating system such as OS X, Linux, Darwin, Windows CE, Windows XP, Symbian OS, or the like, perhaps with support for Java. The device may have the ability to receive DVB-T transmissions and/or the ability to send and receive UMTS, GPRS, or other transmissions.

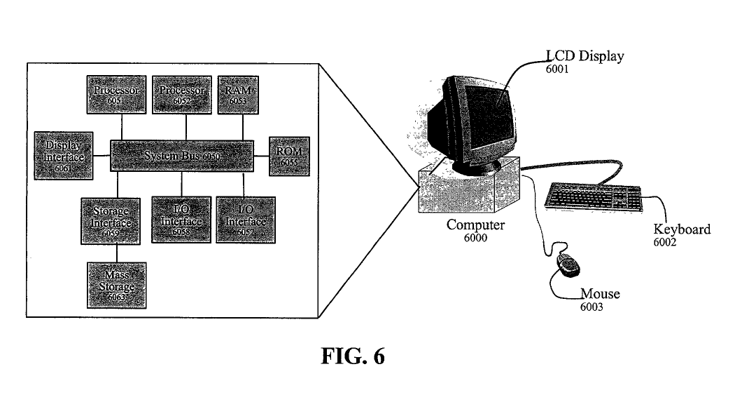

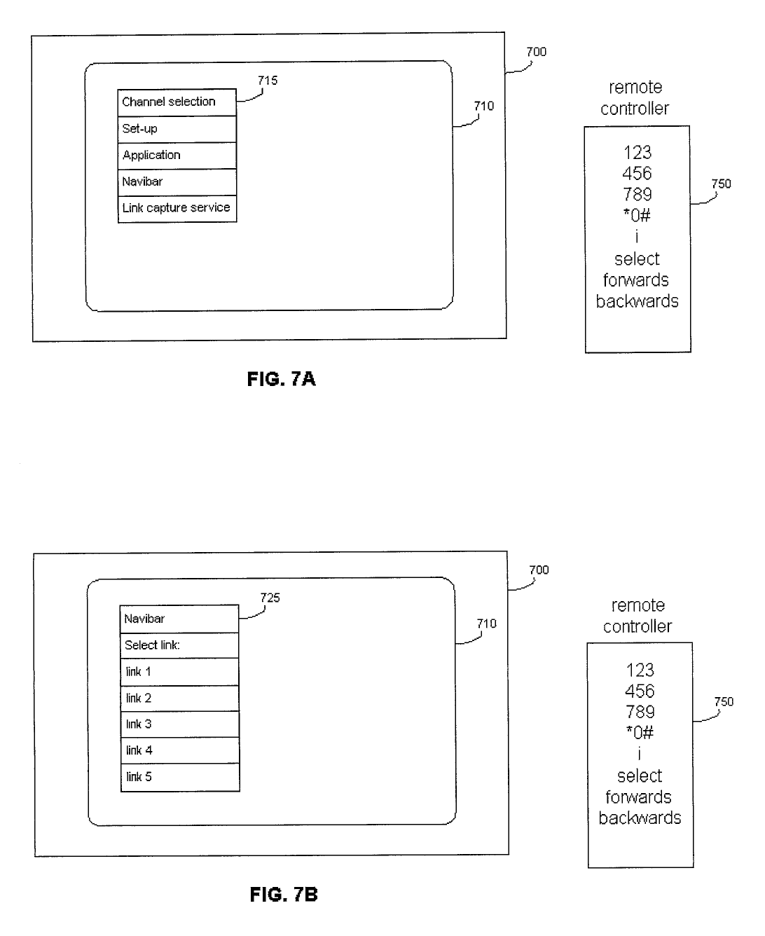

The phrases “General purpose computer,” “computer,” and the like also refer, but are not limited to, one or more processors operatively connected to one or more memory or storage units, wherein the memory or storage may contain data, algorithms, and/or program code, and the processor or processors may execute the program code and/or manipulate the program code, data, and/or algorithms. Accordingly, exemplary computer 6000 as shown in FIG. 6 includes system bus 6050 which operatively connects two processors 6051 and 6052, random access memory (RAM) 6053, read-only memory (ROM) 6055, input output (I/O) interfaces 6057 and 6058, storage interface 6059, and display interface 6061. Storage interface 6059 in turn connects to mass storage 6063. Each of I/O interfaces 6057 and 6058 may be an Ethernet, IEEE 1394, IEEE 802.11b or other WLAN (wireless local area network), or other interfaces such as is known in the art including wireless interface connections such as Bluetooth. Mass storage 6063 may be a hard drive, optical disk, or the like. Processors 6057 and 6058 may each be a commonly known processor such as an IBM or Motorola PowerPC or an Intel Pentium.

Computer 6000 as shown in this example also includes an LCD display unit 6001, a keyboard 6002 and a mouse 6003. In alternate embodiments, keyboard 6002 and/or mouse 6003 might be replaced with a pen interface. Computer 6000 may additionally include or be attached to card readers, DVD drives, or floppy disk drives whereby media containing program code may be inserted for the purpose of loading the code onto the computer. In accordance with the present invention, computer 6000 may be programmed using a language such as Java, Objective C, C, C#, or C++ according to methods known in the art to perform the operations described above. Elements described herein such as pull-down menus, buttons, and the like are intended to correspond to graphical user interface (GUI) elements.

According to certain embodiments, a user may interact with webpages and other user interfaces using a remote controller. Shown in FIGS. 7A and 7B is such a remote controller 750. Remote controller 750 could communicate with a set-top box using, for example infrared or Bluetooth communications as is known in the art. Items 715 and 725 show exemplary user interface elements with which a user may interact by way of the remote controller in accordance with the invention as described above.

### Ramifications and Scope

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention.

What is claimed is:

1. A method for improving the efficiency of data transmission, comprising:
receiving at the terminal of a first user data sent out in response to a second user's request;
deciding, based on a predetermined profile, whether to place the received data in the store of the first user's terminal; and
in the case where said data has been stored, retrieving said data from said store in response to the first user's request for said item.

2. A system for improving the efficiency of data transmission, comprising:
a memory having program code stored therein; and
a processor operatively connected to said memory for carrying out instructions in accordance with said stored program code;
wherein said program code, when executed by said processor, causes said processor to perform the steps of:
receiving at the terminal of a first user data sent out in response to a second user's request;
deciding, based on a predetermined profile, whether to place the received data in the store of the first user's terminal; and
in the case where said data has been stored, retrieving said data from said store in response to the first user's request for said item.

3. A method for displaying information related to a television channel's broadcasting, comprising:
placing on a webpage one or more icons coordinated with the channel's broadcasting, said icons acting as hyperlinks to data relating to a predetermined number of programs recently broadcast on the television channel; and
further placing on the webpage an element relating to programming currently being broadcast on the television channel, said element being coordinated with the channel's broadcasting.

4. A webpage for displaying information related to a television channel's broadcasting, comprising:
one or more icons coordinated with the channel's broadcasting, said icons acting as hyperlinks to data relating to a predetermined number of programs recently broadcast on the television channel; and
an element relating to programming currently being broadcast on the television channel, said element being coordinated with the channel's broadcasting.

5. A method for purveying information related to a television channel's broadcasting, comprising:
transmitting along with the channel's television programming data relating to that programming;
placing the transmitted data in a store of a user's device;
placing on a webpage one or more icons coordinated with the channel's broadcasting, said icons acting as hyperlinks to data relating to a predetermined number of programs recently broadcast on the television channel;
further placing on the webpage an element relating to programming currently being broadcast on the television channel, said element being coordinated with the channel's broadcasting; and
retrieving the transmitted data from said store in response to the user's request for that data.

6. A system for purveying information related to a television channel's broadcasting, comprising:
a memory having program code stored therein; and
a processor operatively connected to said memory for carrying out instructions in accordance with said stored program code;
wherein said program code, when executed by said processor, causes said processor to perform the steps of:
transmitting along with the channel's television programming data relating to that programming;
placing the transmitted data in a store of a user's device;
placing on a webpage one or more icons coordinated with the channel's broadcasting, said icons acting as hyperlinks to data relating to a predetermined number of programs recently broadcast on the television channel;
further placing on the webpage an element relating to programming currently being broadcast on the television channel, said element being coordinated with the channel's broadcasting; and
retrieving the transmitted data from said store in response to the user's request for that data.

7. The method of claim 1 wherein said data relates to a webpage.

8. The method of claim 1 wherein said data relates to a newswire story.

9. The method of claim 1 wherein said data relates to a video.

10. The system of claim 2 wherein said data relates to a webpage.

11. The system of claim 2 wherein said data relates to a newswire story.

12. The system of claim 2 wherein said data relates to a video.

13. The method of claim 3 wherein said element is an icon that acts as a hyperlink.

14. The method of claim 13 wherein said icons relating to programs recently broadcast are smaller than the icon relating to programming currently being broadcast.

15. The method of claim 3 wherein said element is a frame displaying data.

16. The method of claim 3 wherein the predetermined number is selected by the user.

17. The webpage of claim 4 wherein said element is an icon that acts as a hyperlink.

18. The webpage of claim 17 wherein said icons relating to programs recently broadcast are smaller than the icon relating to programming currently being broadcast.

19. The webpage of claim 4 wherein said element is a frame displaying data.

20. The webpage of claim 4 wherein the predetermined number is selected by the user.

21. The method of claim 5 wherein said element is an icon that acts as a hyperlink.

22. The method of claim 21 wherein said icons relating to programs recently broadcast are smaller than the icon relating to programming currently being broadcast.

23. The method of claim 5 wherein said element is a frame displaying data.

24. The method of claim 5 wherein the predetermined number is selected by the user.

25. The system of claim 6 wherein said element is an icon that acts as a hyperlink.

26. The system of claim 25 wherein said icons relating to programs recently broadcast are smaller than the icon relating to programming currently being broadcast.

27. The system of claim 6 wherein said element is a frame displaying data.

28. The system of claim 6 wherein the predetermined number is selected by the user.

29. A method for displaying information related to a television channel's broadcasting, comprising:
receiving a request to no longer present on a webpage information relating to a specified broadcast item;
computing the ordinality of recently-broadcast items without taking into account the specified broadcast item; and
configuring the webpage to display one or more icons associated with a certain ordinal group of the recently broadcast items, said group not including said specified item.

30. A system for purveying information related to a television channel's broadcasting, comprising:
a memory having program code stored therein; and
a processor operatively connected to said memory for carrying out instructions in accordance with said stored program code;
wherein said program code, when executed by said processor, causes said processor to perform the steps of:
receiving a request to no longer present on a webpage information relating to a specified broadcast item;
computing the ordinality of recently-broadcast items without taking into account the specified broadcast item; and
configuring the webpage to display one or more icons associated with a certain ordinal group of the recently broadcast items, said group not including said specified item.

31. A method for displaying information related to a television channel's broadcasting, comprising:
receiving an indication of the number of broadcast items to which a particular icon on a webpage should correspond, said webpage being coordinated with said channel's broadcasting;
configuring said icon to be associated with data relating to said number of broadcast items; and
placing on the webpage an element relating to programming currently being broadcast on the television channel, said element being coordinated with said channel's broadcasting.

32. A system for purveying information related to a television channel's broadcasting, comprising:
a memory having program code stored therein; and
a processor operatively connected to said memory for carrying out instructions in accordance with said stored program code;
wherein said program code, when executed by said processor, causes said processor to perform the steps of:
receiving an indication of the number of broadcast items to which a particular icon on a web page should correspond, said webpage being coordinated with said channel's broadcasting;
configuring said icon to be associated with data relating to said number of broadcast items; and
placing on the webpage an element relating to programming currently being broadcast on the television channel, said element being coordinated with said channel's broadcasting.

33. A method for displaying information related to a television channel's broadcasting, comprising:
receiving an indication of particular broadcast items to which an icon on a webpage should correspond, said webpage being coordinated with said channel's broadcasting;
configuring said icon to be associated with data relating to said broadcast items; and
placing on the webpage an element relating to programming currently being broadcast on the television channel, said element being coordinated with said channel's broadcasting.

34. A system for purveying information related to a television channel's broadcasting, comprising:
a memory having program code stored therein; and
a processor operatively connected to said memory for carrying out instructions in accordance with said stored program code;
wherein said program code, when executed by said processor, causes said processor to perform the steps of:
receiving an indication of particular broadcast items to which an icon on a webpage should correspond, said webpage being coordinated with said channel's broadcasting;
configuring said icon to be associated with data relating to said broadcast items; and
placing on the webpage an element relating to programming currently being broadcast on the television channel, said element being coordinated with said channel's broadcasting.
